(19) United States
(12) Patent Application Publication
(10) Pub. No.: US 2012/0221600 A1
(43) Pub. Date: Aug. 30, 2012

(54) Apparatus and Method for Determining a Decision Recommendation in a Network

(75) Inventor: Zheng Yan, Espoo (FI)

(73) Assignee: NOKIA CORPORATION, Espoo (FI)

(21) Appl. No.: 13/505,737

(22) PCT Filed: Nov. 30, 2009
(86) PCT No.: PCT/IB09/55426

§ 371 Date: May 2, 2012

(51) Int. Cl. G06F 17/30

(52) U.S. Cl. 707/769; 707/E17.014

(57) ABSTRACT

An example apparatus is provided that includes a processor and a memory storing executable instructions that in response to execution by the processor cause the apparatus to at least perform a number of operations. The operations include preparing for transmission a query for feedback data regarding a decision to select one of a set of actions in a given context. The query includes an indication of the given context and a decision metric reflecting historical decisions at the apparatus to select the respective action in each of a plurality of contexts. The operations also include receiving feedback data, and calculating a recommendation value as a function thereof. In this regard, the feedback data has been calculated by one or more nodes as a function of the decision metric and another decision metric reflecting historical decisions at the respective node(s).

### TECHNICAL FIELD

Example embodiments of the present invention generally relate to an apparatus and method for decision-making in an ad-hoc network and, more particularly, relate to an apparatus and method for determining a decision recommendation in an ad-hoc network.

### BACKGROUND

The current development towards truly mobile computing and networking has brought on the evolvement of various access technologies that also provide the users with access to the Internet when they are outside their own home network. At present, wireless Internet access is typically based on either short-range wireless systems or mobile networks, or both.

Short-range wireless systems have a typical range of a few tens of meters to one hundred meters. They often combine with systems wired to the Internet to provide communication over long distances. The category of short-range wireless systems includes wireless personal area networks (PANs) and wireless local area networks (WLANs). They have the common feature of operating in unlicensed portions of the radio spectrum, usually either in the 2.4 GHz Industrial, Scientific, and Medical (ISM) band or in the 5 GHz unlicensed band.

Wireless personal area networks are cost-effective and use low power wireless devices that have a typical range of about ten meters. One of the better-known examples of wireless personal area network technology is Bluetooth, which uses the 2.4 GHz ISM band. It provides a peak air link speed of one Mbps, and power consumption low enough for use in personal, portable electronics such as PDAs and mobile phones. Wireless local area networks generally operate at higher peak speeds of about 2 to 100 Mbps and have a longer range, which requires greater power consumption.

The development referred to above has also brought on the evolvement of so-called ad-hoc networks, which offer unrestricted mobility without any underlying infrastructure. The nodes of an ad-hoc network may be mobile or wireless, with examples of such networks including the mobile ad-hoc network (MANET) and the smart sensor network (SSN). Unlike traditional wireless networks, ad-hoc networks need not necessarily rest on an underlying infrastructure, such as base stations. Instead, all the nodes of an ad-hoc network share the responsibility of network formation and management. In an ad-hoc network, each node therefore acts as a router transmitting data/messages to other nodes of the network, and intermediate ad-hoc nodes relay the data/messages between two nodes located far apart from each. Standalone ad-hoc networks are useful at least whenever it is impossible to use a fixed network infrastructure due to geographical, terrestrial, or time constraints, for example. Local ad-hoc networks can also be integrated into legacy networks, such as wireless networks.

### BRIEF SUMMARY

In view of the foregoing background, example embodiments of the present invention are directed to providing a user with a personalized recommendation regarding a set of actions that are selectable by the user, such as whether or not to disclose/share some information (e.g., personal data) to/with one or more other users in a particular context in the ad hoc network. For example, a query may be raised to request sharing personal information with other ad-hoc network nodes or terminals (e.g., a user profile for some local services, comments on another node's voting of a digital content, personal location information etc.). By providing a personalized recommendation, example embodiments of the present invention may enhance the ad hoc network user's data privacy.

Examples of information whose privacy may be further protected by example embodiments of the present invention include the following:
personal location information
personal profile for a service access (e.g., personal identification number—PIN, or other code or identifier)
locally-collected communication data
a query sent to request a service
a response of a query about personal opinion, knowledge and/or content/service information
comments on another node's voting on a digital content
   As illustrated by the foregoing, diverse information and data may be communicated via an ad hoc network for different purposes and in various contexts. Meanwhile, privacy may be considered a subjective issue. Example embodiments of the present invention therefore provides users with a personalized recommendation with context-awareness to facilitate their decision-making such as to disclosure/sharing of their information.

According to one aspect of example embodiments of the present invention, an apparatus is provided that includes a processor and a memory storing executable instructions that in response to execution by the processor cause the apparatus to at least perform a number of operations. The operations include preparing for transmission from the apparatus to one or more network nodes, a query for feedback data regarding a decision to select one of a set of actions in a given context. The query includes an indication of the given context and a decision metric reflecting historical decisions at the apparatus to select the one of the actions in each of a plurality of contexts. The operations also include receiving feedback data from the node(s) in response to the query, where each of the node(s) has calculated respective feedback data as a function of the decision metric for the apparatus and another decision metric reflecting historical decisions at the respective node to select the one of the actions in each of the plurality of contexts. And the operations include calculating a recommendation value as a function of the feedback data from the node(s), where the recommendation value is for deciding to select the one of the actions in the given context.

The recommendation value may comprise two parts generated with similar functions: a first part that may be calculated at a centralized server (e.g., at a trusted service provider), and another, second part that may be calculated by the node (with the apparatus) itself. In such instances, the memory may store executable instructions that in response to execution by the processor cause the apparatus to perform further functions including receiving a first part of the recommendation value (e.g., from the service provider), and calculating the recommendation value as a function of the first part of the recommendation value and the second part of the recommendation value. This first part of the recommendation value may have been calculated as a function of the decision metrics for the apparatus and the node(s), and as a function of historical decisions at the nodes to select the one of the actions in the given context. Even further, the recommendation value may have been calculated as a function of trust values for the node(s), where the trust values are calculated by the service provider for the apparatus and the node(s). The second part of the recommendation value may be similarly calculated further as a function of local trust values for the node(s). These local trust values, however, are calculated by the apparatus and are distinct from the trust values calculated by the service provider. Notably, the trust values may be generated on the basis of the trust values issued by the service provider, and may be further fine-tuned according to recent accumulated experiences at the node.

The decision to select one of a set of actions may more particularly be a decision whether or not to transmit a type of data from the apparatus to a destination in the given context. In such instances, the decision metric may reflect historical decisions at the apparatus to transmit the type of data in each of the plurality of contexts, and the other decision metric for each of the node(s) may reflect historical decisions at the respective node to transmit the type of data in each of the plurality of contexts.

### BRIEF DESCRIPTION OF THE DRAWING(S)

Having thus described the invention in general terms, reference will now be made to the accompanying drawings, which are not necessarily drawn to scale, and wherein:

FIG. 1 illustrates a general communication environment according to example embodiments of the present invention;

FIG. 2 illustrates an apparatus that may be configured to operate within the network architecture of FIG. 1, according to various example embodiments of the present invention;

FIG. 3 illustrates a functional block diagram of nodes interacting with a recommendation service provider according to example embodiments of the present invention; and

FIG. 4 illustrates a control flow diagram according to one example embodiment of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. Reference may be made herein to terms specific to a particular system, architecture or the like, but it should be understood that example embodiments of the present invention may be equally applicable to other similar systems, architectures or the like. For instance, example embodiments of the present invention may be shown and described herein in the context of ad-hoc networks; but it should be understood that example embodiments of the present invention may be equally applied in other types of distributed networks, such as grid computing, pervasive computing, ubiquitous computing, peer-to-peer, cloud computing for Web service or the like.

The terms “data,” “content,” “information,” and similar terms may be used interchangeably, according to some example embodiments of the present invention, to refer to data capable of being transmitted, received, operated on, and/or stored. The term “network” may refer to a group of interconnected computers or other computing devices. Within a network, these computers or other computing devices may be interconnected directly or indirectly by various means including via one or more switches, routers, gateways, access points or the like.

Further, as used herein, the term “circuitry” refers to any or all of the following: (a) hardware-only circuit implementations (such as implementations in only analog and/or digital circuitry); (b) to combinations of circuits and software (and/or firmware), such as (as applicable): (i) a combination of processor(s) or (ii) portions of processor(s)/software (including digital signal processor(s)), software and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

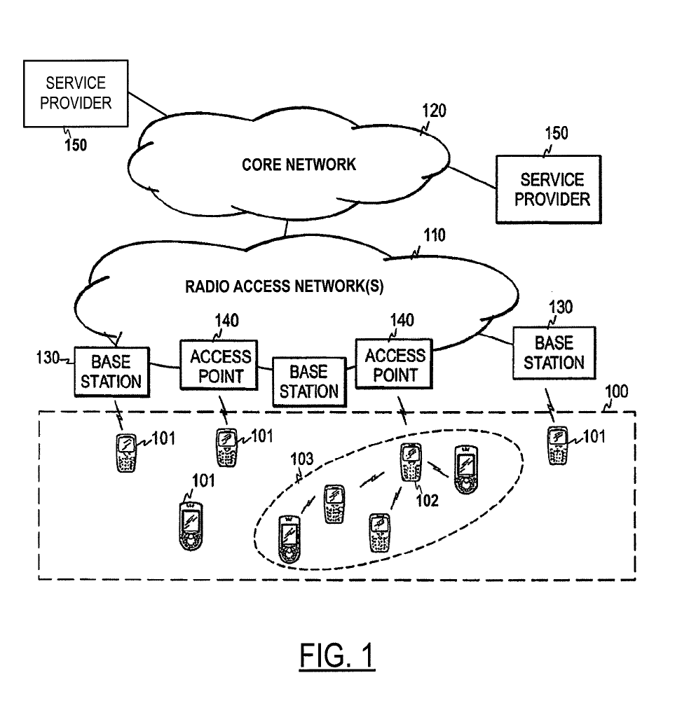

FIG. 1 illustrates a general communication environment in which example embodiments of the present invention may be applied. The communication environment includes three interacting domains: a user equipment domain 100, an access domain including several radio access networks 110, and a backbone domain including a core network 120.

The above communication environment may include a mobile network and one or more short-range wireless networks, and may therefore include one or more base stations 130 (or node B elements), access points 140 or the like. Examples of these networks may include 3GPP radio access networks, UMTS radio access UTRAN (Universal Terrestrial Radio Access Network), GSM radio access networks, CDMA 2000 radio access networks, Wireless Local Area Networks (WLANs) such as IEEE 802.xx networks (e.g., 802.11a, 802.11b, 802.11g, 802.11n, etc.), world interoperability for microwave access (WiMAX) networks, IEEE 802.16, and/or wireless Personal Area Networks (WPANs) such as IEEE 802.15, Bluetooth, low power versions of Bluetooth, infrared (IrDA), ultra wideband (UWB), Wibree, Zigbee or the like. 3GPP radio access networks may include, for example, 3G or 3.9G (also referred to as UTRAN Long Term Evolution (LTE) or Super 3G) or E-UTRAN (Evolved UTRAN) networks. Generally, a radio access network may refer to any 2G, 3G, 4G or higher generation mobile communication network and their different versions, radio frequency (RF) or any of a number of different wireless networks, as well as to any other wireless radio access network that may be arranged to interwork with such networks.

The user equipment domain 100 may include a plurality of mobile terminals 101. In this context, the terminals may be multimode terminals. A multimode terminal here refers to a terminal that has at least two operation modes, i.e., at least two radio interfaces based on different connectivity standards. Although one operation mode may be provided for communicating with the mobile network, the terminal may also be provided with one or more other operation modes, in which a short-range radio of the terminal may be active. The terminals may have different states with respect to each operation mode, and the states allowed concurrently depend on the implementation of the terminal.

The mobile terminals 101 may also form ad-hoc networks 103 in which the terminals (sometimes referred to herein as “nodes”) may communicate directly or indirectly with each other, such as in accordance with various ones of the above manners by which the radio access networks may be configured to communicate. As explained herein, the ad-hoc network may be a mobile ad-hoc network (MANET), but it should be understood that any of a number of different types of ad hoc networks may employ example embodiments of the present invention. The ad-hoc networks may be connected to a radio access network through one or more access points of the access domain. Each ad-hoc network may include at least one trunk node 102 configured to communicate with a base station 130 or access point 140 of the radio access network, and configured to communicate with at least one other ad-hoc node for which the trunk node acts as an access point or gateway. The other nodes may be located at different distances from the trunk node, measured as the number of hops between the node and the trunk node. That is, the trunk node does not have to have a direct connection to each of the other nodes. In such instances, messages between the trunk node and an ad-hoc node may be further than one hop apart from the trunk node and may be relayed by one or more intermediate ad-hoc nodes. Therefore, inside a sub-network served by a trunk node, a connection may involve the end nodes and one or more intermediate nodes. The ad-hoc nodes may also form different sub-networks. The trunk node may also serve more than one ad-hoc network, and with different radio interfaces. In addition to mobile terminals, an ad-hoc network may also include one or more wireless routers, which may also assume the responsibilities of a trunk node. The wireless routers may also be located in the access domain, in which case the ad-hoc networks may penetrate into the access domain.

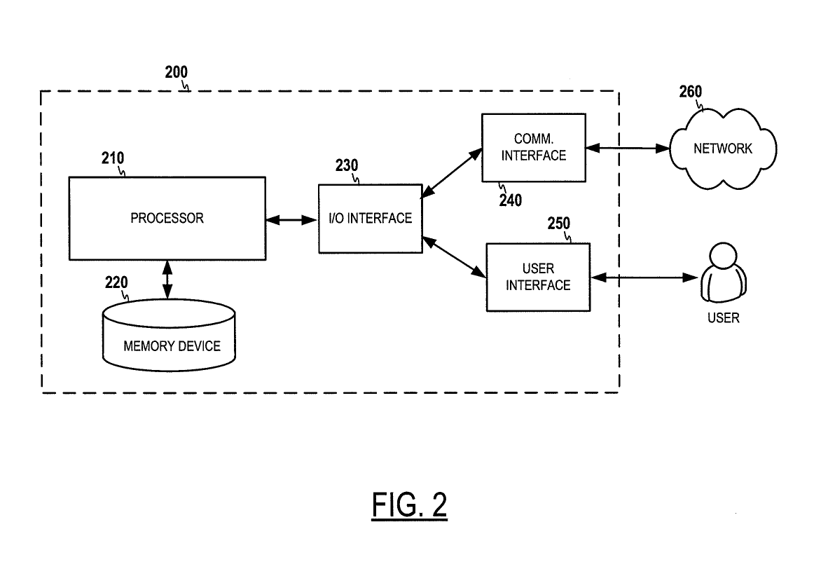

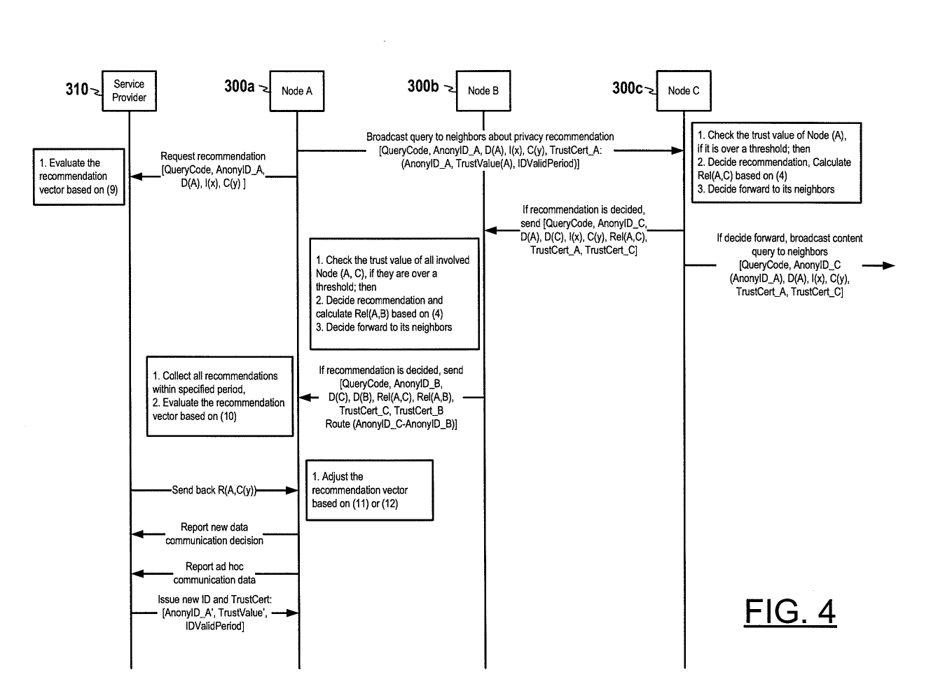

Each local ad-hoc network may thus be connected to an overlaying network infrastructure comprising at least one radio access network 110 and a core network 120. The radio access network and/or the core network may further be connected to one or more external networks, such as the Internet. The core network and/or the external network may include one or more service providers 150. Additionally or alternatively, one or more ad-hoc networks 103 may include one or more service providers. Reference is now made to FIG. 2, which illustrates an apparatus 200 according to example embodiments of the present invention configured to perform the various functionalities described herein. As shown and described herein, the example apparatus may be configured to function as or otherwise implement one or more of the network components depicted in FIG. 1 (e.g., mobile terminal 101, base station 130, access point 140, service provider 150, etc.). The example apparatus depicted in FIG. 2 may also be configured to perform example methods of the present invention, such as those described with respect to FIG. 4.

In some example embodiments, the apparatus 200 may, be embodied as, or included as a component of, a communications device with wired or wireless communications capabilities. In this regard, the apparatus may be configured to operate in accordance with the functionality of one or more network elements as described herein. The example apparatus may include or otherwise be in communication with one or more processors 210, memory devices 220, Input/Output (I/O) interfaces 230, communications interfaces 240 and/or user interfaces 250 (one of each being shown). The processor may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, the processor may be representative of a plurality of processors, or one or more multiple core processors, operating in concert. Further, the processor may be comprised of a plurality of transistors, logic gates, a clock (e.g., oscillator), other circuitry, and the like to facilitate performance of the functionality described herein. The processor may, but need not, include one or more accompanying digital signal processors. In some example embodiments, the processor is configured to execute instructions stored in the memory device or instructions otherwise accessible to the processor. The processor may be configured to operate such that the processor causes the apparatus to perform various functionalities described herein.

Whether configured as hardware or via instructions stored on a computer-readable storage medium, or by a combination thereof, the processor 210 may be an entity capable of performing operations according to embodiments of the present invention while configured accordingly. Thus, in example embodiments where the processor is embodied as, or is part of, an ASIC, FPGA, or the like, the processor is specifically configured hardware for conducting the operations described herein. Alternatively, in example embodiments where the processor is embodied as an executor of instructions stored on a computer-readable storage medium, the instructions specifically configure the processor to perform the algorithms and operations described herein. In some example embodiments, the processor is a processor of a specific device configured for employing example embodiments of the present invention by further configuration of the processor via executed instructions for performing the algorithms, methods, and operations described herein.

The memory device 220 may be one or more computer-readable storage media that may include volatile and/or non-volatile memory. In some example embodiments, the memory device includes Random Access Memory (RAM) including dynamic and/or static RAM, on-chip or off-chip cache memory, and/or the like. Further, the memory device may include non-volatile memory, which may be embedded and/or removable, and may include, for example, read-only memory, flash memory, magnetic storage devices (e.g., hard disks, floppy disk drives, magnetic tape, etc.), optical disc drives and/or media, non- volatile random access memory (NVRAM), and/or the like. The memory device may include a cache area for temporary storage of data. In this regard, at least a portion or the entire memory device may be included within the processor 210.

Further, the memory device 220 may be configured to store information, data, applications, computer-readable program code instructions, and/or the like for enabling the processor 210 and the example apparatus 200 to carry out various functions in accordance with example embodiments of the present invention described herein. For example, the memory device may be configured to buffer input data for processing by the processor. Additionally, or alternatively, the memory device may be configured to store instructions for execution by the processor. The memory may be securely protected, with the integrity of the data stored therein being ensured. In this regard, data access may be checked with authentication and authorized based on access control policies.

The I/O interface 230 may be any device, circuitry, or means embodied in hardware, software or a combination of hardware and software that is configured to interface the processor 210 with other circuitry or devices, such as the communications interface 240 and/or the user interface 250. In some example embodiments, the processor may interface with the memory device via the I/O interface. The I/O interface may be configured to convert signals and data into a form that may be interpreted by the processor. The I/O interface may also perform buffering of inputs and outputs to support the operation of the processor. According to some example embodiments, the processor and the I/O interface may be combined onto a single chip or integrated circuit configured to perform, or cause the apparatus 200 to perform, various functionalities of the present invention.

The communication interface 240 may be any device or means embodied in hardware, software or a combination of hardware and software that is configured to receive and/or transmit data from/to one or more networks 260 (e.g., radio access networks 110, core networks 120, etc.) and/or any other device or module (e.g., other similar apparatuses such as to form an ad-hoc network 103) in communication with the example apparatus 200. The processor 210 may also be configured to facilitate communications via the communications interface by, for example, controlling hardware included within the communications interface. In this regard, the communication interface may include, for example, one or more antennas, a transmitter, a receiver, a transceiver and/or supporting hardware, including, for example, a processor for enabling communications. Via the communication interface, the example apparatus may communicate with various other network elements in a device-to-device fashion and/or via indirect communications.

The communications interface 240 may be configured to provide for communications in accordance with any of a number of wired or wireless communication standards. The communications interface may be configured to support communications in multiple antenna environments, such as multiple input multiple output (MIMO) environments. Further, the communications interface may be configured to support orthogonal frequency division multiplexed (OFDM) signaling. In some example embodiments, the communications interface may be configured to communicate in accordance with various techniques including, as explained above, any of a number of 2G, 3G, 4G or higher generation mobile communication technologies, RF, IrDA or any of a number of different wireless networking techniques. The communications interface may also be configured to support communications at the network layer, possibly via Internet Protocol (IP).

The user interface 250 may be in communication with the processor 210 to receive user input via the user interface and/or to present output to a user as, for example, audible, visual, mechanical or other output indications. The user interface may include, for example, a keyboard, a mouse, a joystick, a display (e.g., a touch screen display), a microphone, a speaker, or other input/output mechanisms. Further, the processor may comprise, or be in communication with, user interface circuitry configured to control at least some functions of one or more elements of the user interface. The processor and/or user interface circuitry may be configured to control one or more functions of one or more elements of the user interface through computer program instructions (e.g., software and/or firmware) stored on a memory accessible to the processor (e.g., the memory device 220). In some example embodiments, the user interface circuitry is configured to facilitate user control of at least some functions of the apparatus 200 through the use of a display and configured to respond to user inputs. The processor may also comprise, or be in communication with, display circuitry configured to display at least a portion of a user interface, the display and the display circuitry configured to facilitate user control of at least some functions of apparatus.

Example embodiments of the present invention are directed to a context-aware recommendation system. More particularly, in accordance with example embodiments of the present invention, one or more nodes (e.g., mobile terminals 101) in an ad-hoc network 103 may each calculate a recommendation value regarding a set of selectable actions, or may otherwise supply another mobile terminal or recommendation service provider with feedback data from which the other mobile node may calculate a recommendation value. The recommendation value(s) may be multi-dimensional based on context and data type, and may be expressed as a recommendation vector. The recommendation value(s) or vector may then be used by a user to faciltiate the user's selection of one of the actions.

The actions as described herein may include whether or not to transmit data (e.g., personal data, personal comments or collected ad-hoc network communication data) from the user's node to another device such as another node, a service provider 150 or the like. It should be understood, however, that the set of actions may comprise any of a number of different actions that may be selected by a user. As also described herein, the node requesting or otherwise receiving or calculating a recommendation value may be considered a “recommendee” or “recommendee node,” whereas the other nodes calculating a recommendation value may be considered “recommenders” or “recommender nodes.”

In accordance with example embodiments of the present invention, the recommendation value(s) or vector may be generated as a function of a number of different variables such as:
node population (number of nodes involved for recommendation)
context for the set of selectable actions (e.g., what kind of ad hoc data service requires/requests the user's data)
the type (e.g., sensitivity) of the user's data being required/requested
similarity of past user decisions regarding the transmission of user data in different contexts
the trust of the recommender nodes providing a recommendation (e.g., calculated based on the respective recommender node's trust values in various contexts—whereby the context's correlation may be considered in the recommendation calculation)
a community to which the recommendee node belongs where a recommendation value may be given greater weight if the recommender node providing the value falls into the same community as the recommendee node
the trust of the destination of the user's data, such as another node or a service provider 150

Example embodiments of the present invention may support anonimity of the ad-hoc network nodes by providing a service provider 150 (e.g., within the ad-hoc network 103, core network 120, etc.) that has a pre-established trust relationship with the nodes and is configured to issue a temporary node identifier (ID) to each node either periodically or by request. This service provider may be referred to herein as a “recommendation service provider.” Communication among the nodes may then be based on the temporary anonymous ID with only the respective nodes and the recommendation service provider knowing the real or actual IDs of the nodes. Examples of the real or actual ID of a node may include a Mobile Station International Subscriber Directory Number (MSISDN), International Mobile Subscriber Identity (IMSI), International Mobile Equipment Identity (IMEI), Internet identifier (e.g. IM, email or social networking identifier) or any of a number of other identifiers by which the node may be accessed independent of the recommendation service provider.

The recommendation service provider may be configured to calculate a recommendation vector for a requesting node (e.g., mobile terminal 101) of the ad-hoc network as a function of feedback data from one or more other nodes, whereby this feedback data may be calculated based on the accumulated experiences of the other nodes. This recommendation vector may be supplied to the requesting node, which may further fine tune the recommendation vector as a function of locally-accumulated experiences of the requesting node.

To further illustrate example embodiments of the present invention, consider an example scenario in which a first ad-hoc network node sends a query to its neighbor nodes about a nearby restaurant, e.g., in a football stadium. Supposed that a set of neighbor nodes respond the query, and based on their responses, and the user of the first node selects a restaurant would like to reserve a table. The restaurant's reservation service, however, requires some personal data (e.g., name, identifier, credit card number, etc.) to reserve a table. The user of the first node would like to know if it is safe to provide the personal data to that restaurant, and hence needs to decide whether or not to send the user's personal data to the restaurant. In order to assist the user's decision, the user casuses the first node to send an additional query to the neighbor nodes to ask for recommendations. The first node may then collect feedback data from the other nodes (e.g., collected within the query response path) and calculate and present the user with a recommendation vector as a function of the feedback data, thereby facilitating the user's decision in this context. It is also possible for the first node to communicate with a service provider, which may be configured to calculate and provide the first node with a recommendation vector. In this regard, the neighbor nodes may interact with the service provider, such as to share their feedback data (e.g., data communication historical information) with the service provider.

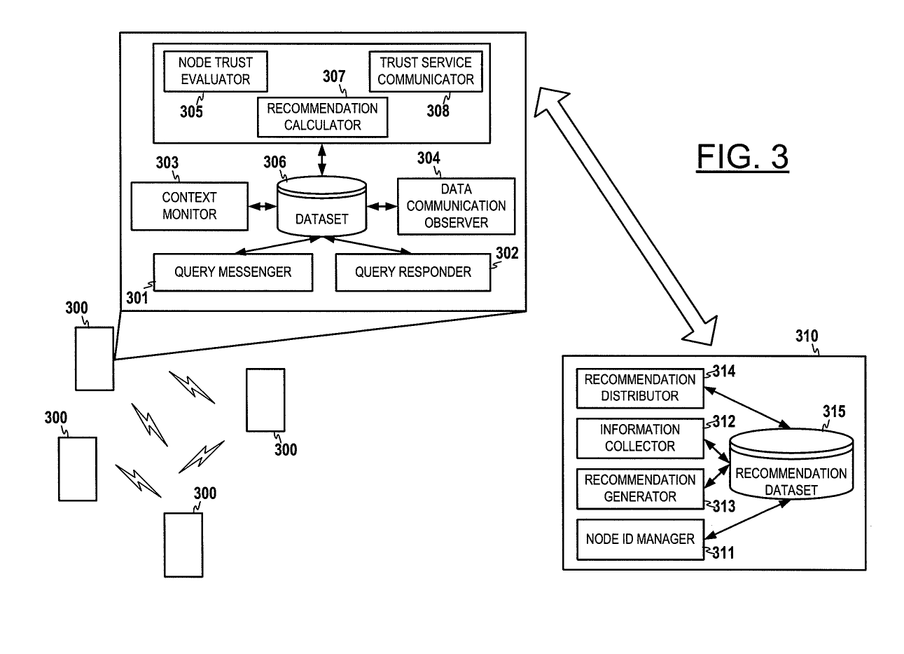

Reference is now made to FIG. 3 which illustrates a functional block diagram of nodes 300 interacting with a recommendation service provider 310 according to example embodiments of the present invention. As shown in FIG. 3, the nodes and recommendation service provider may be configured to implement a number of software modules, engines, components, programs or the like, that may be executed by a processor (hardware) of the respective nodes and service provider. It should be understood, however, that any one or more of these software modules, engines, components, programs or the like may alternatively be implemented solely in hardware or in a combination of hardware and firmware.

As shown in FIG. 3, at one or more nodes 300 of an ad-hoc network 103, a query messager 301 may be configured to send a query to other ad-hoc network nodes and collects responds. A query responder 302, on the other hand, may be configured to receive a query from another ad-hoc network node and send a response to the query. A context monitor 303 may be configured to extract context data and classify contexts based on a context classification model, and a data communication observer 304 may be configured to observe the user behaviour about data processing and communications. The node trust evaluator 305 may be configured to calculate a node trust value based on locally-accumulated experiences and/or a recommendation service provider-issued node trust certificate. The dataset 306 in the node may be configured to store the data related to the recommendation vector calculation (e.g., user data sharing decisions). A recommendation calculator 307 may be configured to calculate a recommendation vector or otherwise fine tune a calculated recommendation vector as a function of the node trust values calculated as a function of locally-accumulated experiences of the responding nodes. And a trust service communicator 308 may be configured to handle communication with the recommendation service provider 310.

At the recommendation service provider 310, a node ID manager 311 may be configured to issue anonymous IDs to the nodes 300 and maintain a correlation between the respective nodes' actual IDs and their anonymous IDs. An information collector 312 may be configured to collect useful information calculating a recommendation vector. A recommendation generator 313 may be configured to calculate the recommendation vector as a function of one or more of the following variables: 1) node population; 2) context; 3) user data type; 4) similarity of past user decisions in different contexts; 5) the trust value of the recommender node(s); 6) the node community; or 7) the trust of the destination of the user's data being shared. A recommendation distributor 314 may be configured to send the recommendation vector to the node. And a recommendation dataset 315 may be configured to store recommendation vector(s) and/or the data from which the vector(s) are calculated.

Reference is now made to FIG. 4, which illustrates a control flow diagram according to one example embodiment of the present invention. The control flow diagram of FIG. 4 illustrates message flows and functions between a recommendee node A 300a and recommender nodes B and C 300b, 300c, and a recommendation service provider 310. It should be understood that example embodiments of the present invention are equally applicable to instances including more or less nodes, as well as instances without a recommendation service provider (e.g., with the recommendee node A being configured to perform the functions of the recommendation service provider).

For purposes of example, suppose that node A has a set of L user data I={i₁, i₂, . . . i_{L}} that may be required in M contexts C={c₁, c₂, . . . c_{M}} in ad-hoc network data services. Also suppose that the ad-hoc network includes K network nodes N={n₁, n₂, . . . n_{K}} (e.g., N={A, B, C}) that may contribute to the recommendation. The probability that node n will share data i in the context c, then, may be represented as follows:

p_{i,n,c}=t_{i,n,c}/T_{i,n,c} (1)

where p_{i,n,c} represents the probability, t represents the number of instances node n shared data i in context c, and T represents a total number of instances in which node n has been requested to share data i in context c.

For node nₖ, the following data sharing decision metric may be defined to reflect the respective node's historical data-sharing decisions:

$$D ( {n}_{k} ) = \{ \{ \begin{matrix}{p}_{{i}_{1} , {n}_{k} , {c}_{1}} \\ {p}_{{i}_{2} , {n}_{k} , {c}_{1}} \\ ⋮ \\ {p}_{{i}_{L} , {n}_{k} , {c}_{1}}\end{matrix} \} … \{ \begin{matrix}{p}_{{i}_{1} , {n}_{k} , {c}_{<}} \\ {p}_{{i}_{2} , {n}_{k} , {c}_{M}} \\ ⋮ \\ {p}_{{i}_{L} , {n}_{k} , {c}_{M}}\end{matrix} \} \} \qquad ( 2 )$$

And the following data sharing decision metric may be defined to represent the historical data-sharing decisions of all of the nodes:

$$D ( N ) = \{ \begin{matrix}\{ \begin{matrix}{p}_{{i}_{1} , {n}_{1} , {c}_{1}} \\ {p}_{{i}_{2} , {n}_{1} , {c}_{1}} \\ ⋮ \\ {p}_{{i}_{L} , {n}_{1} , {c}_{1}}\end{matrix} \} … \{ \begin{matrix}{p}_{{i}_{1} , {n}_{1} , {c}_{M}} \\ {p}_{{i}_{2} , {n}_{1} , {c}_{M}} \\ ⋮ \\ {p}_{{i}_{L} , {n}_{1} , {c}_{M}}\end{matrix} \} \\ ⋮ … ⋮ \\ \{ \begin{matrix}{p}_{1 , {n}_{K} , {c}_{1}} \\ {p}_{{i}_{2} , {n}_{K} , {c}_{1}} \\ ⋮ \\ {p}_{{i}_{L} , {n}_{K} , {c}_{1}}\end{matrix} \} … \{ \begin{matrix}{p}_{1 , {n}_{K} , {c}_{M}} \\ {p}_{{i}_{2} , {n}_{k} , {c}_{M}} \\ ⋮ \\ {p}_{{i}_{L} , {n}_{K} , {c}_{M}}\end{matrix} \}\end{matrix} \} \qquad ( 3 )$$

As shown in FIG. 4, node A 300a sends a query to receive feedback data from other nodes (nodes B and C 300b, 300c) regarding a decision whether or not to share personal data of the user of node A. This query may include one or more of a code or identifier associated with the query, QueryCode, that may identify the query and/or specify a purpose of the query (e.g., the type of query), and that may include the valid period for collecting feedback. The query may also include node A's anonymous ID, AnonyID_A, node A's data sharing decision metric, D(A), a data type, iₓ (1≦x≦L), and/or context data, c_{y} (1≦y≦M). Additionally, the query may also include a trust certificate of node A issued by the recommendation service provider 310, TrustCert_A, which may include node A's anonmyous ID, a trust value for node A, TrustValue(A), and an indication of a period of time for which node A's anonymous ID is valid, IDValidPeriod.

Node C 300c receives the query from node A 300a and checks node A's trust certificate, TrustCert_A. If node A's trust value is equal to or exceeds a threshold, node C may calculate feedback data based on the query; otherwise, node C may cease processing the query. In this regard, a recommender node such as node C may calculate the feedback data in any of a number of different manners. For example, a node nₖ (e.g., node C 300c) may calculate feedback data, Rel, for a node n₁ (e.g., node A 300a) in accordance with the following:

$$Rel ( {n}_{1} , {n}_{k} ) = M {\sum }_{m = 1}^{M} ( 1 - \sqrt{\frac{{\sum }_{l = 1}^{L} {( {p}_{{i}_{l} , {n}_{1} , {c}_{m}} - {p}_{{i}_{l} , {n}_{k} , {c}_{m}} )}^{2}}{L}} ) \qquad ( 4 )$$

After calculating its feedback data, node C 300c may forward the feedback data back to node A 300a. Node C may forward its feedback data directly back to node A, and may additionally forward node A's query to one or more other nodes of the ad-hoc network. As shown in FIG. 4, in one example embodiment, node C may include its feedback data in a forward of node A's query to one or more other nodes of the ad-hoc network. In this example, node C may forward node A's query to node B 300b. This forward of the query may include one or more of the query's code or identifier, node C's anonymous ID, AnonyID_C, node A's data sharing decision metric, the data type and/or context data. Depending on how the recommendation vector or part of the recommendation vector is calculated (see, e.g., equation (10)), the forward may also include node C's data sharing decision metric, D(C), or the part of the metric related to the particular context data context data, c_{y}. Further, the query may also include the trust certificates of both node A and node C (TrustCert_C) issued by the recommendation service provider 310. Similar to node A's trust certificate, node C's trust certificate may include node C's anonmyous ID, a trust value for node C, TrustValue(C), and an indication of a period of time for which node C's anonymous ID is valid, IDValidPeriod.

Node B 300b receives the query forward from node C 300c and the trust certificates for both node A 300a and node C. If the trust values of nodes A and C are equal to or exceed a threshold, node B may calculate its own feedback data based on the query; otherwise, node B may cease processing the query. Node B may calculate its feedback data in a manner similar to that of node C, and may then forward its feedback data directly back to node A, or forward its feedback with the query on to another node in the network. This process may continue for a predetermined period of time with the query received at each node including the feedback data collected from previous recipients of the query, and possibly also including the route of nodes by which the query arrived at the respective node. The last node to process the query, then, may forward to the recommendee node (e.g., node A) a collection of feedback data including its feedback data and the feedback data of the other nodes processing the query (received from the query responder and this responder's forwarders).

Before, after or as node A 300a receives feedback data from other nodes (nodes B and C 300b, 300c), node A may send to the recommendation service provider 310 a query similar to the query sent to the other nodes. The query sent to the recommendation service provider may include a query code or identifier, node A's anonymous ID and data sharing decision metric, the data type and/or context data. The recommendation service provider may receive its query and calculate a first part of the recommendation vector based on the query. The recommendation service provider may calculate the first part of the recommendation vector in any of a number of different manners. In one example embodiment, the first part of the recommendation vector for a node n₁ (e.g. node A in FIG. 4) may be calculated in accordance with the following:

$${R}_{{n}_{1} , {c}_{y}} = \frac{{\sum }_{k = 2}^{K} ( {p}_{{n}_{k} , {c}_{y}} Rel ( {n}_{1} , {n}_{k} ) )}{{\sum }_{k = 2}^{K} Rel ( {n}_{1} , {n}_{k} )} \qquad ( 5 )$$

In more particular example embodiments, the recommendation service provider 310 may calculate the first part of the recommendation vector in a manner that further accounts for a number of additional variables. These variables may include the influence of the number of recommender nodes (e.g., nodes B and C 300b, 300c), the trust of the recommender nodes, the trust of the destination of the user's data being shared, and/or whether the recommender and recommendee are in the same community. In such instances, a credibility of the recommendation contributed by the population of recommender nodes may be defined as follows:

$${N}_{p} = \{ 1 - exp ( \frac{- {K}^{2}}{2 {σ}^{2}} ) \} \qquad ( 6 )$$

In the preceding, σ>0 represents a parameter that inversely controls how fast the number of recommender's impact on the first part of the recommendation vector R, which may increase as the number of nodes K increases. The variable σ may be set from zero to infinity to capture the characteristics of different scenarios.

The trust of a recommender node (e.g., node B, C 300b, 300c) may be calculated by the recommendation service provider 310 based on the respective node's trust values in various contexts. For contexts considered in an ad-hoc network environment, C={c₁, c₂, . . . c_{M}}, the trust value of a node corresponding to each context may be represented as:

$${T}_{{n}_{k}} = \{ \begin{matrix}{t}_{{n}_{k} , {c}_{1}} \\ {t}_{{n}_{k} , {c}_{2}} \\ ⋮ \\ {t}_{{n}_{k} , {c}_{M}}\end{matrix} \} \qquad ( 7 )$$

The trust value calculation for a target context c, then, may be calculated as follows:

$${T}_{{n}_{k} , c} = \frac{{\sum }_{y = 1}^{M} Cor ( c , {c}_{y} ) {t}_{{n}_{k} , {c}_{y}}}{{\sum }_{y = 1}^{M} Cor ( c , {c}_{y} )} \qquad ( 8 )$$

In the preceding, Cor represents a correlation function, which may be defined according to language correlation theory for contexts that are described by some sentence or keywords, although the exact nature of the correlation function may depend on how the contexts are expressed.

Thus, letting Tₙ_{ₖ} represent the trust value of the recommender node nₖ, and T_{d} represent the trust of the destination of the user's data being shared, the recommendation service provider 310 may calculate the first part of the recommendation vector for a node n₁ as follows:

$${R}_{{n}_{1} , {c}_{y}} = \frac{{\sum }_{k = 2}^{K} ( {p}_{{n}_{k} , {c}_{y}} Rel ( {n}_{1} , {n}_{k} ) {λ}_{{n}_{1} , {n}_{k}} {T}_{{n}_{k}} )}{{\sum }_{k = 2}^{K} Rel ( {n}_{1} , {n}_{k } )} \times {N}_{p} \times {T}_{d} \qquad ( 9 )$$

where λₙ_{₁}_{,n}_{ₖ} represents a community factor, λₙ_{₁}_{,n}_{ₖ}=ω if n₁ and nₖ are in the same community and λₙ_{₁}_{,n}_{ₖ}=ω′, ω>ω′ if n₁ and nₖ are in different communities. Regardless of the manner by which the recommendation service provider calculates the first part of the recommendation vector, however, the recommendation service provider may send the vector to the requesting node (e.g., node A 300a).

Once node A 300a receives feedback data from nodes B and C 300b, 300c, node A may calculate a second part of the recommendation vector based on trust values of the other nodes calculated as a function of locally-accumulated experiences of node A. This second part of the recommendation vector may be calculated in a number of different manners. In one example embodiment, the second part of the recommendation vector may be calculated in accordance with the following:

$${R}_{{n}_{1} , {c}_{y}}^{′} = \frac{{\sum }_{k = 2}^{K} ( {p}_{{n}_{k} , {c}_{y}} Rel ( {n}_{1} , {n}_{k} ) {T}_{{n}_{k}}^{′} )}{{\sum }_{k = 2}^{K} Rel ( {n}_{1} , {n}_{k} )} \times {N}_{p} \times {T}_{d}^{′} \qquad ( 10 )$$

where T′ₙ_{ₖ} and T^{′}_{d} represent trust values generated based on the local experience of the recommendee node (e.g., node A)—and which may be calculated by the recommendee node in a manner similar to that shown above with respect to (7) and (8). Notably, each context dimension of the trust value may be generated on the basis of the trust values issued by the service provider, and may be further fine-tuned according to recent accumulated experiences at the recommendee node.

After receiving the first part of the recommendation vector from the recommendation service provider 310, and as or after the second part of the recommendation vector is calculated, node A 300a may fine tune the first part of the recommendation vector as a function of the second part of the recommendation vector (vector based on locally-accumulated experiences of the node A). The first part of the recommendation vector may be fine tuned to calculate a final recommendation vector in a number of different manners, such as in accordance with the following:

R^{f}ₙ_{₁}_{,c}_{_{y}}=αR′ₙ_{₁}_{,c}_{_{y}}+(1−α)Rₙ_{₁}_{,c}_{_{y}} (11)

where α<1 represents a parameter used to weight considerations on direct experience by the recommendee node (e.g., node A) and indirect experiences accumulated at the recommendation server. Alternatively, the first part of the recommendation vector may be fine tuned in accordance with the following set of equations (12):

$$x = \frac{1}{2} - \vert {R}_{{n}_{1} , {c}_{y}}^{′} - {R}_{{n}_{1} , {c}_{y}} \vert \\ f ( g ) = \frac{1}{1 + {e}^{- g}} \\ {R}_{{n}_{1} , {c}_{y}}^{f} = f \{ {R}_{{n}_{1} , {c}_{y}} ( exp ( x ) ) \} \qquad ( 12 )$$

After calculating the final recommendation vector, node A 300a may then make a decision as to whether or not to share its user's data with a respective destination based on the final recommendation vector. This decision may be made automatically by the respective node such as based on a predetermined threshold vector, or may be made by presenting the user with the final recommendation vector and receiving a decision from the user. The node A may also report its decision to the recommendation service provider 310 as a new data communication decision, and may also report its ad-hoc network communication data, which may be utilized in calculating future recommendation vectors. And at the appropriate time, the recommendation service provider may issue a new anonymous ID and upgraded trust certificate to one or more of the nodes.

According to one aspect of the example embodiments of present invention, the functions performed by the apparatus 200, such as those illustrated by the control flow diagram of FIG. 4, may be performed by various means. It will be understood that each block or operation of the control flow diagram, and/or combinations of blocks or operations in the control flow diagram, can be implemented by various means. Means for implementing the blocks or operations of the control flow diagram, combinations of the blocks or operations in the control flow diagram, or other functionality of example embodiments of the present invention described herein may include hardware, and/or a computer program product including a computer-readable storage medium having one or more computer program code instructions, program instructions, or executable computer-readable program code instructions stored therein. In this regard, program code instructions may be stored on a memory device, such as the memory device 220 of the example apparatus, and executed by a processor, such as the processor 210 of the example apparatus. As will be appreciated, any such program code instructions may be loaded onto a computer or other programmable apparatus (e.g., processor, memory device, or the like) from a computer-readable storage medium to produce a particular machine, such that the particular machine becomes a means for implementing the functions specified in the control flow diagram's block(s) or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the control flow diagram's block(s) or operation(s). The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the control flow diagram's block(s) or operation(s).

Accordingly, execution of instructions associated with the blocks or operations of the control flow diagram by a processor, or storage of instructions associated with the blocks or operations of the control flow diagram in a computer-readable storage medium, supports combinations of operations for performing the specified functions. It will also be understood that one or more blocks or operations of the control flow diagram, and combinations of blocks or operations in the control flow diagram, may be implemented by special purpose hardware-based computer systems and/or processors which perform the specified functions, or combinations of special purpose hardware and program code instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

1.-28. (canceled)

29. An apparatus comprising a processor and a memory storing executable instructions that in response to execution by the processor cause the apparatus to at least perform the following:
prepare for transmission from the apparatus to one or more network nodes, a query for feedback data regarding a decision to select one of a set of actions in a given context, the query comprising an indication of the given context and a decision metric reflecting historical decisions at the apparatus to select the one of the actions in each of a plurality of contexts;
receive feedback data from the one or more nodes in response to the query, each of the one or more nodes having calculated respective feedback data as a function of the decision metric for the apparatus and another decision metric reflecting historical decisions at the respective node to select the one of the actions in each of the plurality of contexts; and
calculate a recommendation value as a function of the feedback data from the one or more nodes, the recommendation value for deciding to select the one of the actions in the given context.

30. The apparatus of claim 29, wherein calculate a recommendation value comprises calculate a second part of the recommendation value, and wherein the memory stores executable instructions that in response to execution by the processor cause the apparatus to further perform the following:
receive a first part of the recommendation value calculated as a function of the decision metrics for the apparatus and the one or more nodes, and as a function of historical decisions at the nodes to select the one of the actions in the given context; and
calculate the recommendation value as a function of the first part of the recommendation value and the second part of the recommendation value.

31. The apparatus of claim 30, wherein receive a first part of the recommendation value comprises receive, from a service provider, a first part of the recommendation value calculated further as a function of trust values for the one or more nodes, the trust values being calculated by the service provider for the apparatus and the one or more nodes.

32. The apparatus of claim 31, wherein calculate a second part of the recommendation value comprises calculate a second part of the recommendation value further as a function of local trust values for the one or more nodes, the local trust values being calculated by the apparatus and being distinct from the trust values calculated by the service provider.

33. The apparatus of claim 29, wherein the decision to select one of a set of actions comprises a decision whether or not to transmit a type of data from the apparatus to a destination in the given context, the decision metric reflecting historical decisions at the apparatus to transmit the type of data in each of the plurality of contexts, and
wherein the other decision metric for each of the one or more nodes reflects historical decisions at the respective node to transmit the type of data in each of the plurality of contexts.

34. The apparatus of claim 33, wherein calculate a recommendation value comprises calculate a second part of the recommendation value, and wherein the memory stores executable instructions that in response to execution by the processor cause the apparatus to further perform the following:
receive a first part of the recommendation value calculated as a function of the decision metrics for the apparatus and the one or more nodes, and as a function of historical decisions at the nodes to transmit the type of data in the given context; and
calculate the recommendation value as a function of the first part of the recommendation value and the second part of the recommendation value.

35. An apparatus comprising a processor and a memory storing executable instructions that in response to execution by the processor cause the apparatus to at least perform the following:
receive a query for feedback data regarding a decision to select, at a node, one of a set of actions in a given context, the query comprising an indication of the given context and a decision metric reflecting historical decisions at the node to select the one of the actions in each of a plurality of contexts;
calculate feedback data in response to the query, the feedback data being calculated as a function of the decision metric for the node and another decision metric reflecting historical decisions at another network node to select the one of the actions in each of the plurality of contexts; and
prepare for transmission, the feedback data or a value calculated as a function of the feedback data.

36. The apparatus of claim 35, wherein the memory stores executable instructions that in response to execution by the processor cause the apparatus to further perform the following:
calculate a recommendation value as a function of the feedback data, and as a function of historical decisions at the other node to select the one of the actions in the given context,
wherein prepare for transmission comprises preparing the recommendation value for transmission to the node.

37. The apparatus of claim 36, wherein calculate a recommendation value comprises calculate a recommendation value at a service provider, the recommendation value being calculated further as a function of trust values for the one or more other nodes, the trust values being calculated by the service provider for the node and the one or more other nodes.

38. The apparatus of claim 37, wherein prepare the recommendation value for transmission comprises prepare the recommendation value for transmission to the node for the node to calculate a second part of the recommendation value, the second part of the recommendation value being calculated as a function of local trust values for the one or more other nodes, the local trust values being calculated by the node and being distinct from the trust values calculated by the service provider.

39. The apparatus of claim 35, wherein the decision to select one of a set of actions comprises a decision whether or not to transmit a type of data from the node to a destination in the given context, the decision metric reflecting historical decisions at the node to transmit the type of data in each of the plurality of contexts, and
wherein the other decision metric reflects historical decisions at the other node to transmit the type of data in each of the plurality of contexts.

40. The apparatus of claim 39, wherein the memory stores executable instructions that in response to execution by the processor cause the apparatus to further perform the following:
calculate a recommendation value as a function of the feedback data, and as a function of historical decisions at the other node to transmit the type of data in the given context,
wherein prepare for transmission comprises prepare the recommendation value for transmission to the node.

41. The apparatus of claim 35, wherein prepare for transmission comprises prepare for transmission, a forward of the query to a further node, the forward comprising the query and the feedback data, the forward being prepared for transmission to enable the further node to calculate further feedback data as a function of the decision metric for the node and a further decision metric reflecting historical decisions at the further network node, and to prepare for transmission the feedback data.

42. The apparatus of claim 35, wherein receive a query comprises receive a forward of a query, the forward comprising the query and additional feedback data, the additional feedback data having been calculated as a function of the decision metric for the node and an additional decision metric reflecting historical decisions at an additional network node to select the one of the actions in each of the plurality of contexts, and
wherein prepare for transmission comprises prepare for transmission, the feedback data and the additional feedback data.

43. A method comprising:
preparing for transmission from one network node to one or more other network nodes, a query for feedback data regarding a decision to select one of a set of actions in a given context, the query comprising an indication of the given context and a decision metric reflecting historical decisions at the node to select the one of the actions in each of a plurality of contexts;
receiving feedback data from the one or more other nodes in response to the query, each of the one or more other nodes having calculated respective feedback data as a function of the decision metric for the node and another decision metric reflecting historical decisions at the respective other node to select the one of the actions in each of the plurality of contexts; and
calculating a recommendation value as a function of the feedback data from the one or more other nodes, the recommendation value for deciding to select the one of the actions in the given context.

44. The method of claim 43, wherein calculating a recommendation value comprises calculating a second part of the recommendation value, and wherein the method further comprises:
receiving a first part of the recommendation value calculated as a function of the decision metrics for the node and the one or more other nodes, and as a function of historical decisions at the other nodes to select the one of the actions in the given context; and
calculating the recommendation value as a function of the first part of the recommendation value and the second part of the recommendation value.

45. The method of claim 44, wherein receiving a first part of the recommendation value comprises receiving, from a service provider, a first part of the recommendation value calculated further as a function of trust values for the one or more other nodes, the trust values being calculated by the service provider for the node and the one or more other nodes.

46. The method of claim 45, wherein calculating a second part of the recommendation value comprises calculating a second part of the recommendation value further as a function of local trust values for the one or more other nodes, the local trust values being calculated by the node and being distinct from the trust values calculated by the service provider.

47. The method of claim 43, wherein the decision to select one of a set of actions comprises a decision whether or not to transmit a type of data from the node to a destination in the given context, the decision metric reflecting historical decisions at the node to transmit the type of data in each of the plurality of contexts, and
wherein the other decision metric for each of the one or more other nodes reflects historical decisions at the respective other node to transmit the type of data in each of the plurality of contexts.

48. The method of claim 47, wherein calculating a recommendation value comprises calculating a second part of the recommendation value, and wherein the method further comprises:
receiving a first part of the recommendation value calculated as a function of the decision metrics for the node and the one or more other nodes, and as a function of historical decisions at the other nodes to transmit the type of data in the given context; and
calculating the recommendation value as a function of the first part of the recommendation value and the second part of the recommendation value.
